(19) United States
(12) Patent Application Publication
(10) Pub. No.: US 2017/0325508 A1
(43) Pub. Date: Nov. 16, 2017

(54) Electronic Cigarette with Analog Display Arrangement

(71) Applicant: Mutual Vape Inc, Glendora, CA (US)

(72) Inventor: Xu SUN, Zhuzhou (CN)

(73) Assignee: Mutual Vape Inc

(21) Appl. No.: 15/595,279

(22) Filed: May 15, 2017

(30) Foreign Application Priority Data
May 15, 2016 (CN) 201620438513.5
Jan. 5, 2017 (CN) 201720010165.6

(51) Int. Cl. A24F 47/00; G05G 1/08; H05B 1/02

(52) U.S. Cl. CPC A24F 47/008; H05B 1/0244; G05G 1/08; H05B 2203/021

(57) ABSTRACT

An electronic cigarette includes a cigarette body, a cartridge, an atomizer supported in the cigarette body, a control circuitry and an analog display arrangement. The analog display arrangement includes an analog display dial provided on the cigarette body, an indicating pointer movably provided on the analog display dial, a driving unit provided in the cigarette body and connected to the indicating pointer for driving the indicating pointer to move on the analog display dial. The driving unit is connected to the control circuitry for displaying an operational parameter of the electronic cigarette in an analog manner.

### BACKGROUND OF THE PRESENT INVENTION

### Field of Invention

The present invention relates to an electronic cigarette, and more particularly to an electronic cigarette with an analog display arrangement which is capable of displaying operational parameters by an analog display dial.

### Description of Related Arts

A conventional electronic cigarette usually comprises a main body, a cigarette cartridge accommodated in the main body for storing a predetermined liquid solution, a heating element supported in the main body for heating or vaporizing the liquid solution stored in the cartridge, and a Liquid Crystal Display (LCD) screen or Light Emitting Diode (LED) screen provided on the main body for display the various operational parameters of the electronic cigarette.

A major disadvantage of the conventional electronic cigarettes such as the one described above is that the displays are invariably either a LCD screen or a LED screen. In other words, the operational parameters are usually display in digital format which in some situations may be difficult to observe. Moreover, the overall style of the digital display has become very dull. The LCD screen or the LED screen is usually incorporated in the electronic cigarette so that when the screen is broken, the entire electronic cigarette must be replaced.

As a result, there is a need to improve upon conventional electronic cigarettes and develop an electronic cigarette which is capable of displaying operational parameters by an analog display.

### SUMMARY OF THE PRESENT INVENTION

Certain variations of the present invention provide an electronic cigarette which comprises an analog display arrangement which is capable of displaying operational parameters by an analog display dial.

In one aspect of the present invention, it provides an electronic cigarette, comprising:

a cigarette body;

a cartridge supported in the cigarette body for storing a predetermined amount of liquid solution;

an atomizer supported in the cigarette body for vaporizing the liquid solution retrieved from the cartridge;

a control circuitry comprising a main microprocessor connected to the atomizer and the cartridge for controlling a vaporization of the liquid solution; and

an analog display arrangement, which comprises:

an analog display dial provided on the cigarette body;

an indicating pointer movably provided on the analog display dial;

a driving unit provided in the cigarette body and connected to the indicating pointer for driving the indicating pointer to move on the analog display dial, the driving unit being connected to the control circuitry for displaying an operational parameter of the electronic cigarette in an analog manner.

In another aspect of the present invention, it provides an electronic cigarette, comprising:

a cigarette body;

a cartridge supported in the cigarette body for storing a predetermined amount of liquid solution;

an atomizer supported in the cigarette body for vaporizing the liquid solution retrieved from the cartridge;

a control circuitry comprising a main microprocessor connected to the atomizer and the cartridge for controlling a vaporization of the liquid solution; and

an analog display arrangement, which comprises:

a display circuitry, which comprises a display PCB supported in the cigarette body, and a display controlling microprocessor mounted on the display PCB, at least one operational parameter of the cartridge and the atomizer being transmitted to the display controlling microprocessor;

an analog display dial provided on the cigarette body;

an indicating pointer movably provided on the analog display dial; and

a driving unit provided in the cigarette body and connected to the indicating pointer for driving the indicating pointer to move on the analog display dial, the driving unit being connected to and controlled by the display controlling microprocessor for displaying the operational parameter of the electronic cigarette in an analog manner.

This summary presented above is provided merely to introduce certain concepts and not to identify any key or essential features of the claimed subject matter.

### BRIEF DESCRIPTION OF THE DRAWINGS

FIG. 1 is a perspective view of an electronic cigarette according to a preferred embodiment of the present invention.

FIG. 2 is a perspective view of an analog display arrangement according to the preferred embodiment of the present invention.

FIG. 3 is a block diagram of the electronic cigarette according to a preferred embodiment of the present invention.

FIG. 4 is a schematic diagram of the analog display arrangement according to a first alternative mode of the present invention.

FIG. 5 is a schematic diagram of the analog display arrangement according to a second alternative mode of the present invention.

FIG. 6 is a block diagram of the analog display arrangement according to the second alternative mode of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

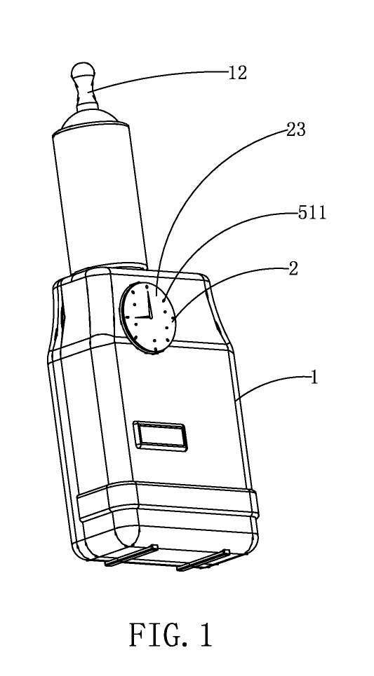

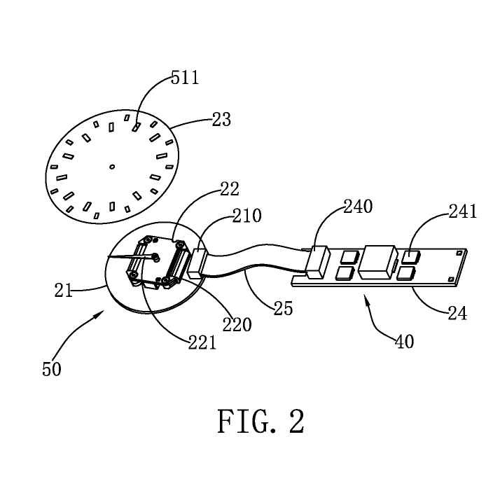

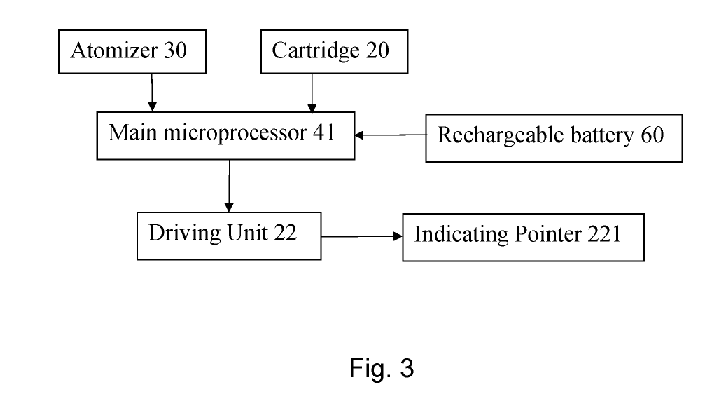

Referring to FIGS. 1 to 3 of the drawings, an electronic cigarette according a preferred embodiment of the present invention is illustrated. Broadly, the electronic cigarette may comprise a cigarette body 1 having a receiving cavity, a cartridge 20, an atomizer 30, a control circuity 40, and an analog display arrangement 50.

The cartridge 20 may be supported in the cigarette body 1 for storing a predetermined amount of liquid solution. The atomizer 30 may be supported in the cigarette body 1 for vaporizing the liquid solution retrieved from the cartridge 20.

The control circuitry 40 may comprise a main microprocessor 241 electrically connected to the atomizer 30 and the cartridge 20 for controlling a vaporization of the liquid solution.

The analog display arrangement 50 may comprise an analog display dial 23, an indicating pointer 221, and a driving unit 22. The analog display dial 23 may be provided on the cigarette body 1. The indicating pointer 221 may be movably provided on the analog display dial 23. Moreover, the driving unit 22 may be provided in the cigarette body 1 and may be connected to the indicating pointer 221 for driving the indicating pointer 221 to move on the analog display dial 23. The driving unit 22 may be connected to the control circuitry 40 for displaying an operational parameter of the electronic cigarette in an analog manner.

According to the preferred embodiment of the present invention, the cigarette body 1 may be configured to have a wide variety of configurations and shapes. An exemplary configuration and shape is illustrated in FIG. 1 of the drawings. The main body 1 may comprise a mouthpiece 12 provided at an end portion thereof for allowing a user to inhale vapor through the mouthpiece 12.

The cartridge 20 may be supported in the cigarette body 1 for storing a predetermined amount of liquid solution. The liquid solution stored in the cartridge 20 may be controllably released to the atomizer 30 for being heated and vaporized and finally delivered to the user through the mouthpiece 12. The rate and manner in which the liquid solution is released by the cartridge 20 may be controlled by the control circuity 40. Thus, the cartridge 20 may be electrically connected to the control circuitry 40.

The atomizer 30 may be provided in the cigarette body 1 for heating and vaporizing the liquid solution released from the cartridge 20. The vaporized liquid solution forms a main product of the electronic cigarette and may be inhaled by a user of the present invention. The temperature and rate of the vaporization of the atomizer 30 may be controlled by the control circuitry 40. Thus, the atomizer 30 may also be electrically connected to the control circuitry 40.

The control circuitry 40 may comprise a control Printed Circuit Board (PCB) 24, at least one main microprocessor 241 implemented on the control PCB 24, and an output port 240 provided on the control PCB 24 for electrically connecting to the analog display arrangement 50 through at least one data cable 25. As described above, the main microprocessor 241 may be configured to control the operation of the cartridge 20 and the atomizer 30.

The analog display dial 23 of the analog display arrangement 50 may be provided on the cigarette body 1 for displaying certain information through the indicating pointer 221. Thus, the analog display dial 23 may have a plurality of parameters markings 511 formed thereon for indicating a particular value of a predetermined operational parameter. For example, a number of temperature markings as the parameters markings 511 may be formed on the analog display dial 23 for indicating the temperature of the vapor delivered by the electronic cigarette. Of course, other operational parameters may also be formed on the analog display dial 51. Time information may also be displayed and indicated by the analog display dial 51.

The analog display arrangement 50 may further comprise a supporting base 21 provided in the cigarette body 1 for supporting the driving unit 22 and the indicating pointer 221. The driving unit 22 may be securely supported by the supporting base 21 in the cigarette body 1. The indicating pointer 221 may be movably and rotatably connected to the driving unit 22 at a position above the analog display dial 23. In this preferred embodiment, the driving unit 22 may be arranged to drive the indicating pointer 221 to incrementally rotate on the analog display dial 23 so as to selectively and controllably point to specific parameters markings 511 (such as a specific temperature). The driving unit 22 may comprise a step motor having a core windings 220 for driving the indicating pointer 221.

The analog display arrangement 50 may further comprises an input port 210 provided on the supporting base 21 and electrically connected to the driving unit 22. The input port 210 and the output port 240 may be electrically connected through the data cable 25. The data cable 25 may be configured from conductive and flexible material.

The electronic cigarette of the present invention may further comprise a rechargeable battery 60 accommodated in the cigarette body 1 and electrically connected to the control circuitry 40 for providing power to the various components of the cigarette body, such as the cartridge 20, the atomizer 30, the control PCB 24, the main microprocessor 241, and the driving unit 22.

The operation of the present invention may be as follows: when a user of the present invention is smoking through the electronic cigarette of the present invention, the operational parameters of the smoking (such as the temperature of the vapor) may be indicated by the indicating pointer 221 which may point toward a parameters marking 511. The user may be able to visually observe the parameter by observing the indicating pointer 221 and the analog display dial 23.

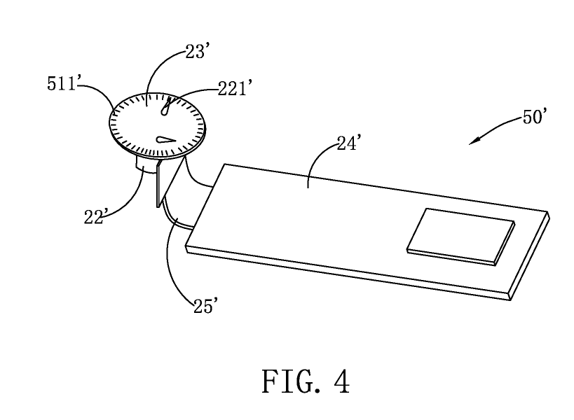

Referring to FIG. 4 of the drawings, a first alternative mode of the electronic cigarette according to preferred embodiment of the present invention is illustrated. The first alternative mode is similar to the preferred embodiment as described above except the analog display arrangement 50′ may be formed as a more compact structure without the use of the supporting base 21. In the first alternative mode, the driving unit 22′ may be configured as a step motor. The control PCB 24′ may be connected to the driving unit 22′ through a data cable 25′. The analog display dial 23′ may be provided above the driving unit 22′ which may be connected to the indicating pointer 221′ in a rotatably movable manner. Parameters markings 511′ may be formed on the analog display dial 23′.

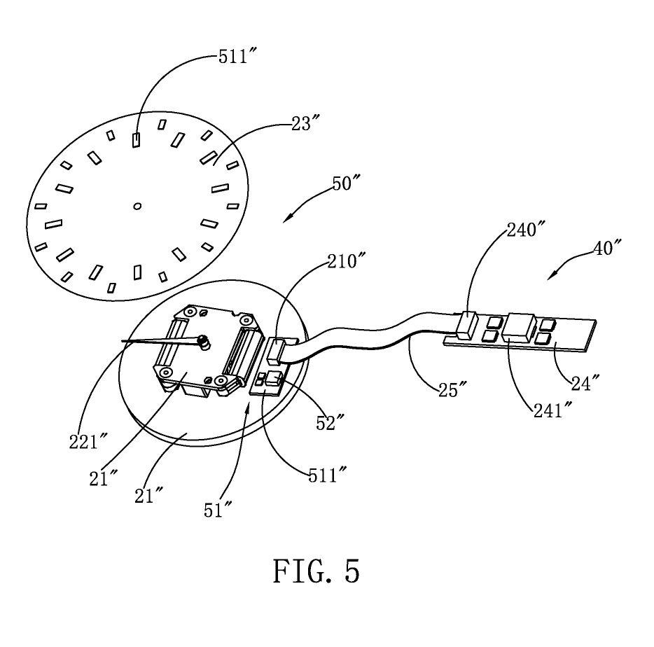

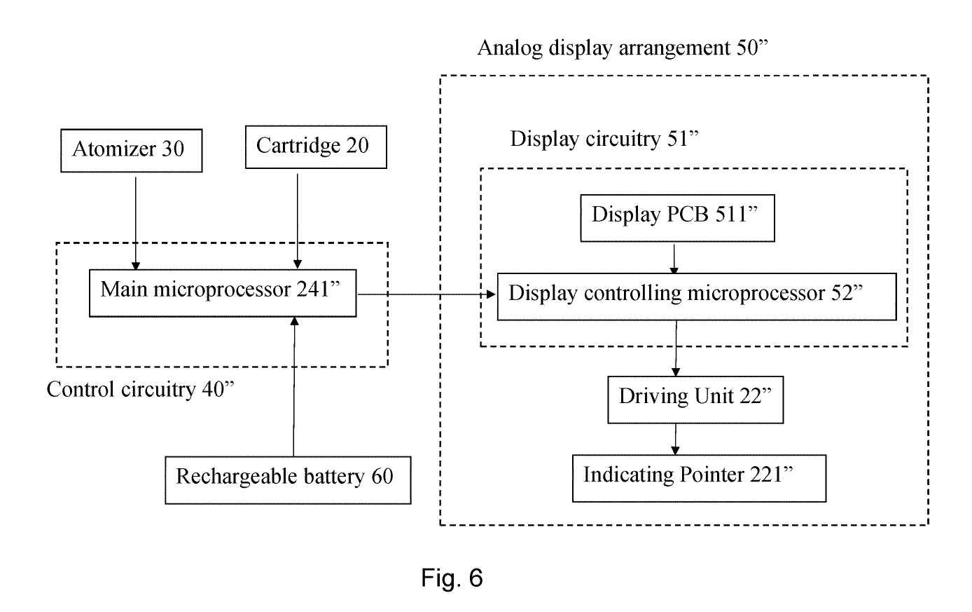

Referring to FIG. 5 and FIG. 6 of the drawings, a second alternative mode of the electronic cigarette according to the preferred embodiment of the present invention is illustrated. The second alternative mode is similar to the preferred embodiment, except the control mechanism of the analog display arrangement 50″ and the control circuit 40″. According to the second alternative mode, the analog display arrangement 50″ may further comprise a display circuitry 51″ provided in the cigarette body 1 for controlling an operation of the driving unit 22″. The display circuitry 51″ may be implemented on a display PCB 511″ which may be supported on the supporting base 21″ and electrically connected to the input port 210″. The analog display arrangement 50″ may further comprise a display controlling microprocessor 52″ mounted on the display PCB 511″. The display controlling microprocessor 52″ may be configured to control and drive an operation of the driving unit 22″, which may be configured as a step motor.

On the other hand, the control circuitry 40″ may be configured to control an operation of the cartridge 20 and the atomizer 30. Operational parameters from the operation of the electronic cigarette may be transmitted from the control circuitry 40″ to the display controlling microprocessor 52″ which may then drive the driving unit 22″ to move the indicating pointer 221″ to point to specific parameter markings 511″ formed on the analog display dial 23″.

Thus, the control circuitry 40″ may comprise a control PCB 24″, a main microcontroller 241″ configured to control an operation of the cartridge 20 and the atomizer 30, and an output port 240″ provided on the control PCB 24″. The control circuitry 40″ may be identical to that described in the preferred embodiment above, except that the main microcontroller 241″ may be configured to control only the cartridge 20 and the atomizer 30. Operational parameters are transmitted to the display controlling microprocessor 52″ through a data cable 25″.

In this second alternative mode of the present invention, the cartridge 20 and the atomizer 30, and the driving unit 22″ may be controlled by two different and separate microprocessors, namely, the main microprocessor 241″ and the display controlling microprocessor 52″ respectively. Signals from the control circuitry 40″ may be transmitted to the display circuitry 51″ through the data cable 25″.

The present invention, while illustrated and described in terms of a preferred embodiment and several alternatives, is not limited to the particular description contained in this specification. Additional alternative or equivalent components could also be used to practice the present invention.

What is claimed is:

1. An electronic cigarette, comprising:
a cigarette body;
a cartridge supported in said cigarette body for storing a predetermined amount of liquid solution;
an atomizer supported in said cigarette body for vaporizing said liquid solution retrieved from said cartridge;
a control circuitry comprising a main microprocessor connected to said atomizer and said cartridge for controlling a vaporization of said liquid solution; and
an analog display arrangement, which comprises:
an analog display dial provided on said cigarette body;
at least one indicating pointer movably provided on said analog display dial;
a driving unit provided in said cigarette body and connected to said indicating pointer for driving said indicating pointer to move on said analog display dial, said driving unit being connected to said control circuitry for displaying an operational parameter of said electronic cigarette in an analog manner.

2. The electronic cigarette, as recited in claim 1, wherein said control circuitry further comprises a control PCB, and an output port provided on said control PCB for electrically connecting to said analog display arrangement, said main microprocessor being implemented on said control PCB.

3. The electronic cigarette, as recited in claim 2, wherein said analog display arrangement further comprises a supporting base provided in said cigarette body for supporting said driving unit and said indicating pointer, said driving unit being securely supported by said supporting base, said indicating pointer being movably and rotatably connected to said driving unit at a position above said analog display dial.

4. The electronic cigarette, as recited in claim 3, wherein said analog display dial has a plurality of parameters markings formed thereon for indicating a particular value of a predetermined operational parameter.

5. The electronic cigarette, as recited in claim 4, wherein said driving unit is arranged to drive said indicating pointer to incrementally rotate on said analog display dial so as to selectively and controllably point to specific parameters markings.

6. The electronic cigarette, as recited in claim 5, further comprising a rechargeable battery accommodated in said cigarette body and electrically connected to said control circuitry for providing power to said cartridge, said atomizer, said control PCB, said main microprocessor, and said driving unit.

7. An electronic cigarette, comprising:
a cigarette body;
a cartridge supported in said cigarette body for storing a predetermined amount of liquid solution;
an atomizer supported in said cigarette body for vaporizing said liquid solution retrieved from said cartridge;
a control circuitry comprising a main microprocessor connected to said atomizer and said cartridge for controlling a vaporization of said liquid solution; and
an analog display arrangement, which comprises:
a display circuitry, which comprises a display PCB supported in said cigarette body, and a display controlling microprocessor mounted on said display PCB, at least one operational parameter of said cartridge and said atomizer being transmitted to said display controlling microprocessor;
an analog display dial provided on said cigarette body;
at least one indicating pointer movably provided on said analog display dial; and
a driving unit provided in said cigarette body and connected to said indicating pointer for driving said indicating pointer to move on said analog display dial, said driving unit being connected to and controlled by said display controlling microprocessor for displaying said operational parameter of said electronic cigarette in an analog manner.

8. The electronic cigarette, as recited in claim 7, wherein said control circuitry further comprises a control PCB, and an output port provided on said control PCB for electrically connecting to said analog display arrangement, said main microprocessor being implemented on said control PCB.

9. The electronic cigarette, as recited in claim 8, wherein said analog display arrangement further comprises a supporting base provided in said cigarette body for supporting said analog display arrangement, said indicating pointer being movably and rotatably connected to said driving unit at a position above said analog display dial.

10. The electronic cigarette, as recited in claim 9, wherein said analog display dial has a plurality of parameters markings formed thereon for indicating a particular value of a predetermined operational parameter.

11. The electronic cigarette, as recited in claim 10, wherein said driving unit is arranged to drive said indicating pointer to incrementally rotate on said analog display dial so as to selectively and controllably point to specific parameters markings.

12. The electronic cigarette, as recited in claim 11, further comprising a rechargeable battery accommodated in said cigarette body and electrically connected to said control circuitry for providing power to said cartridge, said atomizer, said control circuitry and said analog display arrangement.
